(19) United States
(12) Patent Application Publication
(10) Pub. No.: US 2011/0289119 A1
(43) Pub. Date: Nov. 24, 2011

(54) METHODS AND SYSTEMS FOR MONITORING SERVER CLOUD TOPOLOGY AND RESOURCES

(75) Inventors: Joseph Weizhen Hu, Lexington, MA (US); Scott Johns Bacon, Thornton, CO (US); Rahul Singhai, Pune (IN); Vaibhav Subhash Joshi, Pune (IN)

(73) Assignee: Sybase, Inc., Dublin, CA (US)

(21) Appl. No.: 12/784,030

(22) Filed: May 20, 2010

(51) Int. Cl. G06F 17/30; G06F 15/16; G06F 3/048

(52) U.S. Cl. 707/803; 715/853; 707/E17.032

(57) ABSTRACT

Systems, methods and articles of manufacture for monitoring server cloud topology and resources are described herein. An embodiment includes determining a topological relationship of the computing nodes in the server cloud and constructing a data structure representing the topological relationship. The constructed data structure includes a plurality of node managed objects (MOs), where each node managed object corresponds to a computing node in the server cloud. The constructed data structure also includes a plurality of link managed objects, where each link managed object corresponds to inter-node communications between two or more computing nodes represented by the node managed objects. The node managed objects and the link managed objects publish events corresponding to changes affecting computing nodes in the server cloud. Embodiments of the invention generate and display a topology view based on the topological relationship and update the displayed topology view (or portions thereof) based on the published events.

### BACKGROUND

1. Field

Embodiments of the present invention generally relate to cloud computing.

2. Background Art

Cloud computing is a rapidly emerging technology that uses the Internet and a plurality of computing nodes to maintain data and applications. Cloud computing allows for much more efficient computing by centralizing storage, memory, processing and bandwidth.

More businesses are deploying an increasing number of computing nodes or servers to develop their cloud computing infrastructure. Often, such computing nodes are interconnected using different topologies. Computing nodes in a cloud computing infrastructure may occasionally be added or removed based on user preferences or other considerations. Furthermore, communication between the computing nodes may need to be monitored.

Accordingly, systems, methods and articles of manufacture are needed that are scalable and allow efficient and comprehensive monitoring of cloud computing resources.

BRIEF SUMMARY

Embodiments of the present invention relate to monitoring a server cloud that includes a plurality of computing nodes. An embodiment includes determining a topological relationship of the computing nodes in the server cloud and constructing a data structure (e.g., node tree) representing the topological relationship. The constructed data structure includes a plurality of node managed objects (MOs), where each node managed object corresponds to a computing node in the server cloud. The constructed data structure also includes a plurality of link managed objects, where each link managed object corresponds to inter-node communications between two or more computing nodes represented by the node managed objects.

The node managed objects and the link managed objects publish events corresponding to changes affecting computing nodes in the server cloud. Embodiments of the invention generate a topology view based on the topological relationship and update the topology view (or portions thereof) based on the published events. Furthermore, the topology view can be displayed in a browser of a client device (e.g., laptop) allowing a user to view updates to the topology view and also interact with the displayed topology view.

In this way, a topological relationship of a monitored server cloud (or computing nodes) is modeled as a dynamic node tree of managed objects, where the node tree is updated based on, for example, cloud membership and topological relationship of the computing nodes as well as any changes in the server cloud that affect the computing nodes.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates an example system framework, according to an embodiment.

FIG. 2A illustrates a node tree, according to an embodiment.

FIG. 2B illustrates events published by a node tree, according to an embodiment.

FIG. 3 is a flowchart illustrating an operation of managed objects in a node tree, according to an embodiment.

FIG. 4 illustrates subscription of view components to different events, according to an embodiment.

FIG. 5 is a flowchart illustrating an exemplary method to render a topology view, according to an embodiment

FIG. 6 illustrates an exemplary screen-shot of a topology view, according to an embodiment.

FIG. 7 depicts an example computer system in which embodiments of the present invention may be implemented.

Embodiments of the present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the invention.

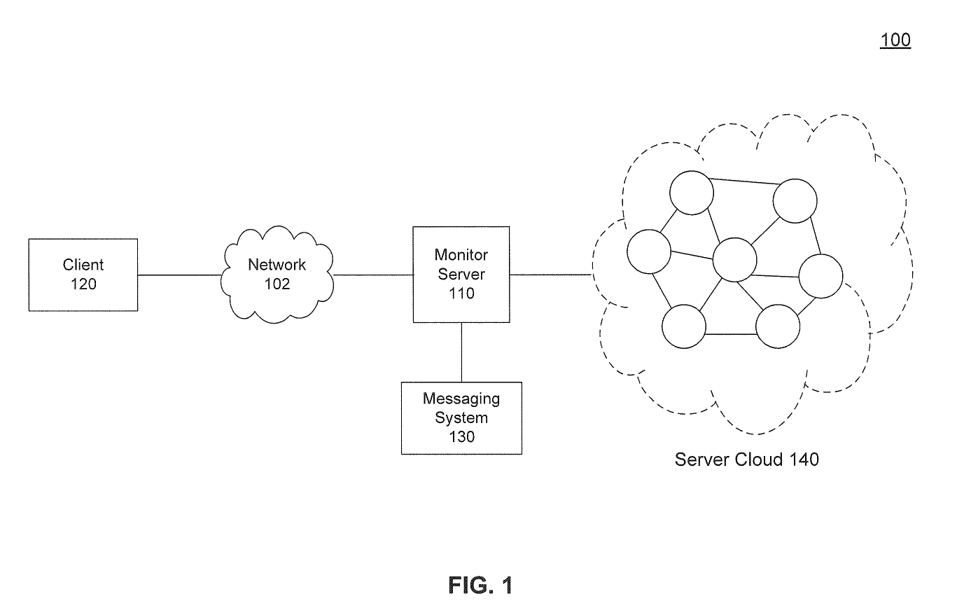

FIG. 1 illustrates system 100, according to an embodiment. As shown in FIG. 1, system 100 includes monitor server 110, client 120, messaging system 130 and server cloud 140.

In an embodiment, server cloud 140 may include a plurality of servers, physical computing nodes and other computing resources arranged in any topological manner. Servers can typically include, but are not limited to, database servers or application servers. It is to be appreciated that server cloud 140 is not limited to servers and can include one or more computing devices (e.g., processor-based computing systems) and computing nodes. Computing nodes can be, for example, single or multi-processor based computing devices that can communicate with other computing nodes, devices and servers within server cloud 140. In other words, servers (or any other computing devices) in server cloud 140 may be interconnected in any manner.

In an embodiment, not intended to limit the invention, server cloud 140 can be a SYBASE IQ computing node multiplex (or infrastructure) that is configured, for example, in a ‘star’ topology. Within such a multiplex, for example, there is one coordinator node and a plurality of secondary nodes. In an embodiment, inter-node communication (INC) can exist between a secondary node and the coordinator node (or between any two or more computing nodes).

In an embodiment, monitor server 110 is configured to monitor a topological relationship of computing nodes in server cloud 140. In an embodiment, monitor server 110 maintains and monitors a dynamic tree data structure (or any other data structure) representing server cloud membership and topological relationships in server cloud 140. As shown in FIG. 1, monitor server 110 communicates with server cloud 140, and also with client 120 and messaging system 130 via network 102. In an embodiment, not intended to limit the invention, monitor server 110 can include one or more modules (e.g., processor-based modules) that are configured to perform one or more of the operations discussed herein. The operation of monitor server 110 is described further below.

Network 102 is optionally either a public or private communications network. In accordance with an embodiment of the present invention, network 102 is the Internet. In accordance with an additional embodiment of the present invention, network 102 is a private intranet, such as a corporate network. Network 102 can be any other form or combination of wired or wireless network.

In an embodiment, client 120 is configured to display a dynamic topology view of computing nodes representing their server cloud membership and topological relationships in server cloud 140. As an example, such display of a topology view is based on a dynamic tree data structure generated by monitor server 110. In an embodiment, client 120 communicates with monitor server 110 to dynamically update a displayed topology representing server cloud 140. In an embodiment, client 120 includes a browser that is configured to display a dynamic topology view in a browser window. In an embodiment, not intended to limit the invention, client 120 can include one or more modules (e.g., processor-based modules) that are configured to perform one or more of the operations discussed herein.

In an embodiment, messaging system 130 is configured to receive an input from monitor server 110 based on changes to node membership, node relationship, state or attributes of computing nodes, and inter-nodal communication links in server cloud 140. In an embodiment, messaging system 130 can include a messaging bus to provide alerts associated with such changes to users via email or any other messaging platform.

Although FIG. 1 illustrates a single monitor server 110, client 120 and messaging system 130, it is to be appreciated that system 100 is scalable and can be configured to operate with any number of clients, monitor servers, messaging systems and other devices.

### Dynamic Node Tree

As discussed above, monitor server 110 monitors a topological relationship of computing nodes and other resources in server cloud 140. To accomplish this, in an embodiment, monitor server 110 maintains a dynamic tree data structure (e.g., node tree) representing membership of computing nodes and their topological relationships in server cloud 140.

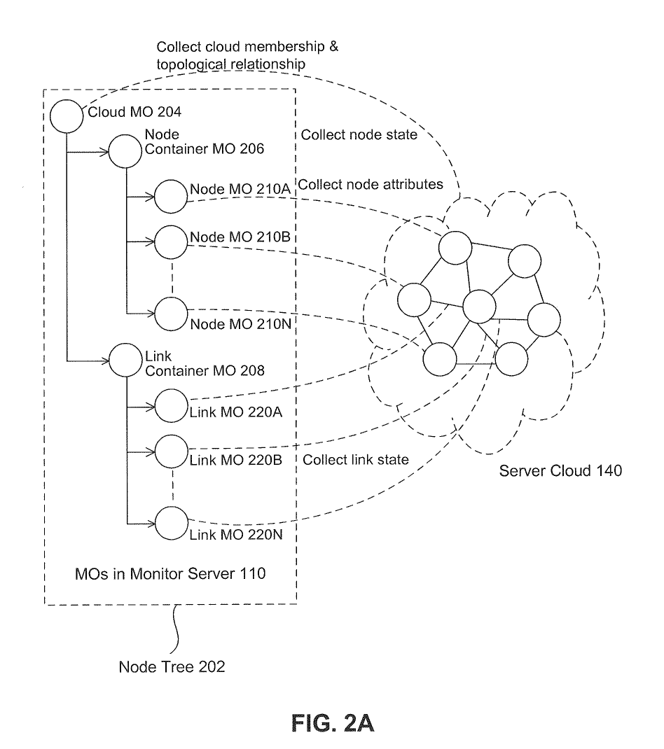

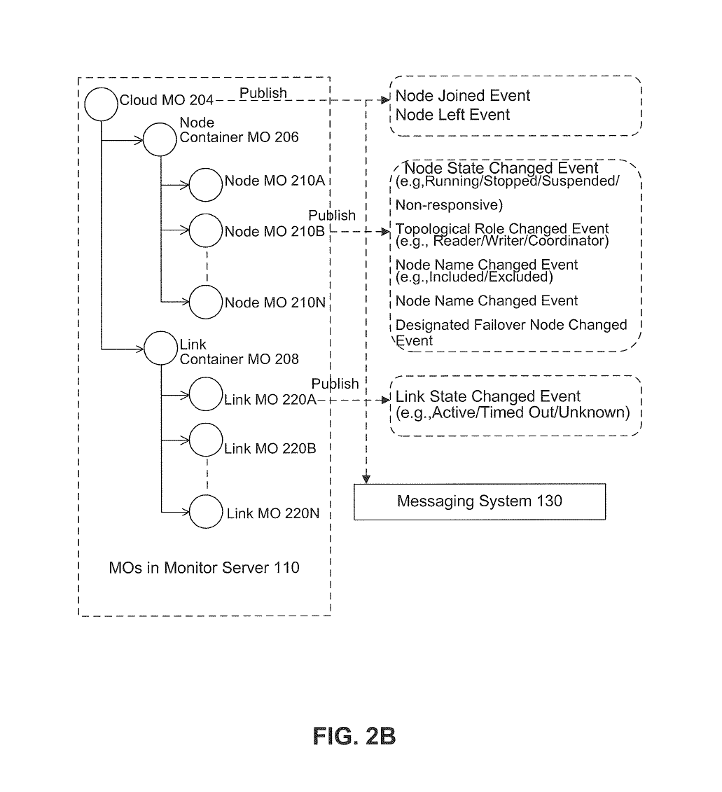

FIG. 2A illustrates an exemplary node tree 202 in monitor server 110. In an embodiment, node tree 202 includes a plurality of node managed objects (MOs) 210A-N that collect data in parallel from server cloud 140. As shown in FIG. 2A, each computing node in server cloud 140 is represented in node tree 202 as a node MO (e.g., node MO 210A) and each inter-node communication link in server cloud 140 is represented as a link MO (e.g., link MO 220A) in node tree 202. In an embodiment, there is a one-to-one correspondence between node MOs 210A-N in node tree 202 and monitored computing nodes in server cloud 140. In a similar manner, there can exist a one-to-one correspondence between inter-node communications between link node MOs 220A-N in node tree 202 and inter-node communications between computing nodes in server cloud 140.

In an embodiment, a topological relationship of nodes in server cloud 140 is obtained by querying on inter-node communications in server cloud 140, along with a ‘topological role’ attribute, which is described further below.

In an embodiment, monitor server 110 can retrieve cloud membership (or node membership) from server cloud 140, or from one or more computing nodes within server cloud 140.

In an embodiment, not intended to limit the invention, MOs in node tree 202 can be hierarchically organized as shown in FIG. 2A. In a hierarchical organization, for example, there can be one root node (e.g., cloud MO 204) and several container nodes (e.g., node container MO 208). The container nodes may further include several child nodes (e.g., node MOs 210A-N).

In an embodiment, because node tree 202 can change its attributes or configuration when a computing node in server cloud 140 is affected by any change, node tree 202 is considered to be dynamic node tree. In other words, when server cloud 140's topological relationship (or portions thereof) changes, node tree 202 maintained at monitor server 110 changes accordingly. Furthermore, in an embodiment, each node MO 210A-N in node tree 202 collects information from server cloud 140 in parallel and asynchronously. In other words, by operating asynchronously, any node MO 210A-N in node tree 202 can collect data from server cloud 140 at anytime and independently of other node MOs in node tree 202. In a similar manner, each link MO 220A-N in node tree 202 collects information from server cloud 140 in parallel and asynchronously.

Referring to FIG. 2A, and in an embodiment, cloud MO 204 is defined at the root of node tree 202. Cloud MO 204 is configured to collect cloud-wide information such as cloud membership and topological relationship in server cloud 140. As an example, such cloud wide information is initial minimal information needed to populate node tree 202. In an embodiment, detailed parameters associated with each node MO 210A-N in node tree 202 can be filled in asynchronously (or at any time) after node tree 202 is initially constructed by monitor server 110. In an embodiment, the structure of node tree 202 in monitor server 110 dynamically adjusts itself based on the information collected by cloud MO 204.

In an embodiment, each node MO 210A-N collects state information and attributes of a corresponding computing node in server cloud 140. The state of a node MO 210A-N in node tree 202 can include, but is not limited to, a state of running, stopped, suspended, or non-responsive. For example, if node MO 210A indicates a ‘non-responsive’ state, it means that the corresponding computing node (e.g., a server) in server cloud 140 is non-responsive. In an embodiment, each node MO 210A-N can store and provide any combination of the following attributes in response to a request from monitor server 110 or client 120:

1. Node Topological Role: A node topological role attribute indicates a node's role or configuration in the topological relationship of server cloud 140. As an example, not intended to limit the invention, the node topological role attribute can have a value of Reader, Writer, or Coordinator.

2. Node Mode: A node mode attribute indicates if a computing node associated with a node MO in node tree 202 has been either included in or excluded from server cloud 140. The node mode attribute can have a value of ‘Included’ or ‘Excluded’.

3. Node Name: A node name attribute represents a name or identifier associated with a computing node in server cloud 140.

4. Designated Failover Node: A designated failover node attribute indicates if a computing node in server cloud 140 is a designated failover node (e.g., a designated failover server) which may be initialized when a primary node fails.

Referring to FIG. 2A, and in an embodiment, each link MO 220A-N collects state and attributes of inter-node communication between two or more computing nodes in server cloud 140. As an example, a link MO's state can have an ‘Active’, ‘Timed Out’, or ‘Unknown’ value. In an embodiment, link MOs 220A-N may be encapsulated within link container MO 208.

Node tree 202 is advantageous because data collection threads of each node MO 210A-N (or link MO 220A-N) in node tree 202 run in parallel. Such parallel operation significantly speeds up data collection from server cloud 140. Furthermore, data can be collected by node tree 202 asynchronously. In other words, any node MO 210A-N (or link MO 220A-N) in node tree 202 may be updated at anytime and independently of other node MOs in node tree 202. Because updates may be obtained asynchronously from server cloud 140, it allows real time updates to node tree 202 and improved update performance.

### Distributed Event System

As discussed above, MOs (i.e., both node MOs 210A-N and link MOs 220A-N) in node tree 202 perform data collection from computing nodes in server cloud 140. In addition, MOs in node tree 202 can also check if there are changes to cloud membership, topological relationship, state or attributes of computing nodes and inter-node communication links in server cloud 140. When such changes to server cloud 140 are detected by node MOs 210A-N, node MOs corresponding to the affected computing nodes publish events representing the changes. The published events are then asynchronously distributed to messaging system 130 as well as to all connected client browsers by a distributed event system in monitor server 110.

Referring to FIG. 2B, the following is an exemplary list of event types published by different MOs in node tree 202.

### I. Node Membership Change Events

In an embodiment, node membership change events are published by cloud MO 204. As an example, such events include, but are not limited to:
a) Node Joined Event: Generated by an MO when a new node joins server cloud 140.
b) Node Left Event: Generated by an MO when a corresponding existing computing node leaves server cloud 140.

### II. Node State/Attribute Change Events:

In an embodiment, node membership change events are published from each node MO 210A-N in node tree 202. As an example, such events include, but are not limited to,
a) Node State Changed Event: Generated by an MO when a corresponding computing node in server cloud 140 stops, begins operation, is suspended or even non-responsive.
b) Node Topological Role Changed Event: Generated by an MO when a corresponding computing node's topological role in server cloud 140 changes. As an example, a computing node in server cloud 140 may become a reader, writer, or coordinator.
c) Node Mode Changed Event: Generated by an MO when a corresponding computing node in server cloud 140 is included into or excluded from server cloud 140.
d) Node Name Changed Event: Generated by an MO when a corresponding computing node's name has changed in server cloud 140.
e) Designated Failover Node Changed Event: Generated by an MO when a corresponding computing node in server cloud 140 becomes a designated failover node, or an existing designated failover node loses its designation.

### III. Link Property Change Events:

In an embodiment, link property change events are published from each link node MO 220A-N in node tree 202. As an example, link state change events are generated by a link node MO when inter-node communication between two or more computing nodes in server cloud 140 becomes active, timed out, or unknown.

In an embodiment, monitor server 110's performance is scalable in tennis of a number of connected client browsers instantiated on client 120. As an example, when client browsers (or clients) increase, the number of operations performed on monitor server 110 doesn't increase, because the total number of MOs in node tree 202 remains constant. The total number of MOs in node tree 202 remains constant because their number is dependent on computing nodes in server cloud 140, and independent of the number of clients associated with monitor server 110.

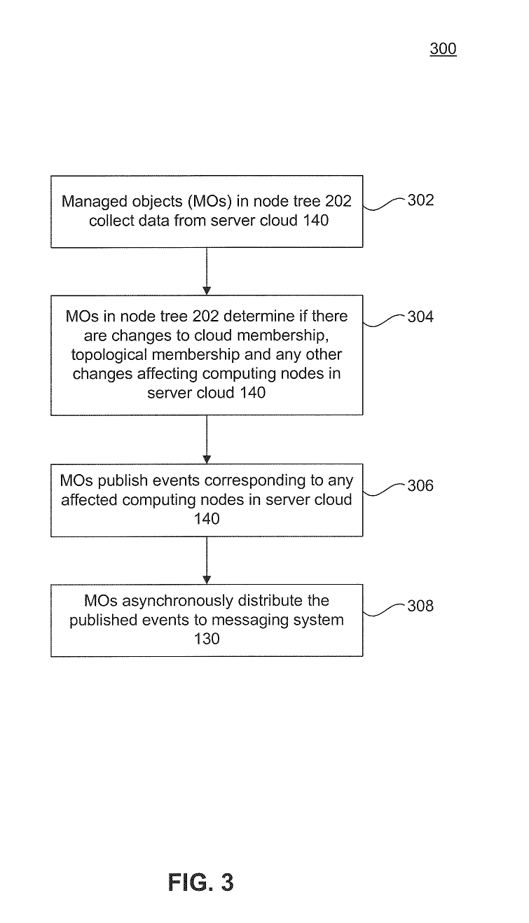

FIG. 3 is a flowchart illustrating an exemplary operation of MOs in node tree 202, according to an embodiment.

In step 302, MOs in node tree 202 collect data from server cloud 140. For example, each node MO 210A-N collects state information and attributes of a corresponding computing node in server cloud 140. Also, for example, cloud MO 204 is configured to collect cloud-wide information such as cloud computing node membership and topological relationships in server cloud 140.

In step 304, MOs in node tree 202 determine if there are changes to cloud membership, topological relationship, state or attributes of computing nodes and communication links in server cloud 140. As an example, a node MO may determine if a corresponding computing node in server cloud 140 has is operative, stopped or suspended.

In step 306, MOs in node tree 202 publish events corresponding to any affected computing nodes in server cloud 140 based on changes determined in step 304. As an example, node membership change events are published by cloud MO 204.

In step 308, MOs in node tree 202 asynchronously distribute the published events to messaging system 130 as well as to all connected client browsers using a distributed event system in monitor server 110. In addition, messaging system 130 can include a messaging bus to provide alerts associated with such events to users via email or any other messaging platform.

In this way, a topological relationship of a monitored server cloud (or computing nodes) is modeled as a dynamic node tree of managed objects, where the node tree is updated based on, for example, cloud membership and topological relationship of the computing nodes as well as any changes in the server cloud that affect the computing nodes.

### Topology View

In an embodiment, a topology view that represents a topology of computing nodes in server cloud 140 is displayed on client 120. Such a topology view can be displayed within a web browser on client 120. As an example, a topology view may be implemented using ADOBE FLEX, the BIRDEYE/RaVis library or any other graphical display and rendering methods known to those skilled in the art.

In an embodiment, there is a one-to-one relationship between nodes/links in a topology view on client 120 and node MOs/link MOs in node tree 202. Upon initialization, client 120 queries monitor server 110 to retrieve node membership and relationship information. Then, topology view components remotely subscribe to different types of events (e.g., node membership change events) that published by MOs in node tree 202. In an embodiment, rendering of information such as states and attributes of nodes and links are delayed at client 120 until event notifications are received from MOs in node tree 202.

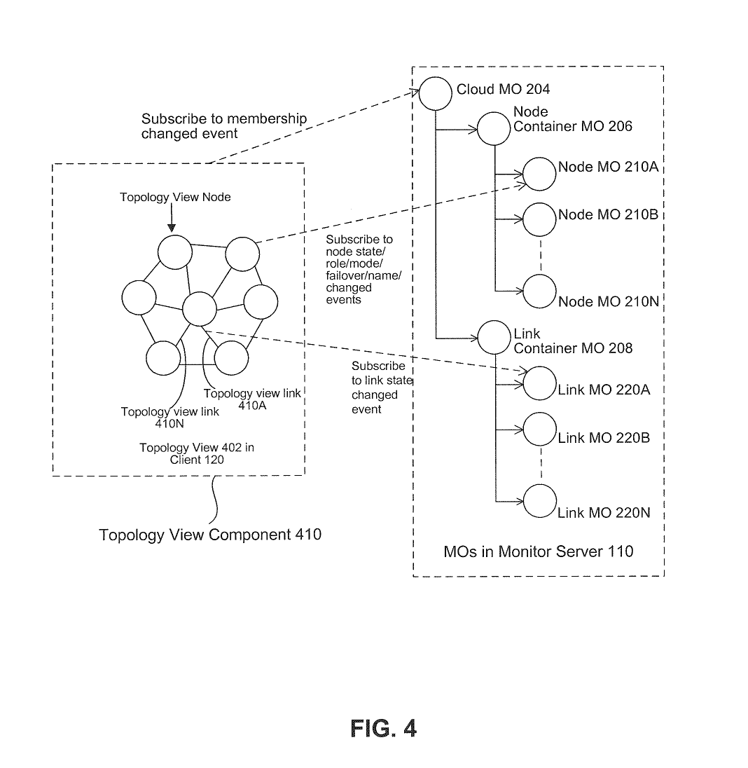

FIG. 4 illustrates topology view components subscribing to different types of events published by MOs in node tree 202, according to an embodiment.

As shown in FIG. 4, topology view component 410 represents topology view 402 and subscribes to ‘node membership changed’ events from cloud MO 204. In an embodiment, when a ‘node membership changed’ event arrives from cloud MO 204, the entirety of topology view 402 is re-drawn by client 120.

In an embodiment, each topology view node in topology view 402 subscribes to the following events that are published from a corresponding node MO in node tree 202:

a. Node State Changed Event

b. Node Role Changed Event

c. Node Mode Changed Event

d. Designated Failover Node Changed Event

e. Node Name Changed Event.

In an embodiment, when events specific to a certain topology view node in topology view 402 arrive, that topology view node is redrawn without redrawing other nodes in topology view 402. For example, when a ‘node name changed’ event is received by topology view 402, the topology view node that is associated with the name change is re-drawn without redrawing other nodes in topology view 402.

In an embodiment, each topology link 410A-N subscribes to a ‘link state changed’ event that is published from a corresponding link MO in node tree 202. In an embodiment, when link events specific to a topology link in topology view 402 are received at client 120, the link is redrawn without redrawing other links in topology view 402.

In this way, events published by MOs in node tree 202 on monitor server 110 arrive at client 120 asynchronously allowing different portions of topology view 402 to be updated at different times. Thus, a user or viewer of topology view 402 need not wait for all topology view nodes in topology view 402 to be rendered at the same time. Furthermore, due to asynchronous rendering at client 120 upon event notification from monitor server 110, topology view 402's performance is scalable in teens of a number of monitored computing nodes.

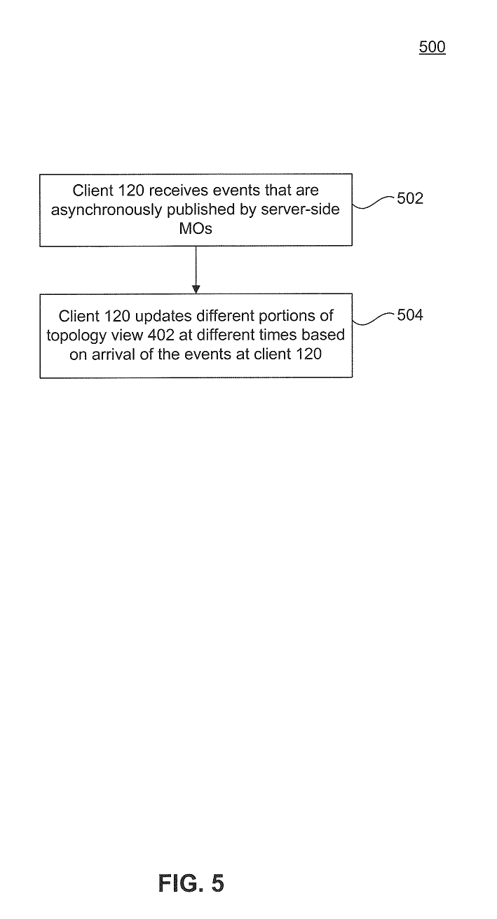

FIG. 5 is a flowchart illustrating an exemplary method to render topology view 402, according to an embodiment.

In step 502, client 120 receives events that are asynchronously published by different types of server-side MOs. As an example, a topology view node in topology view 402 can subscribe to a ‘node state changed’ event published from a corresponding node MO in node tree 202. Such a published event can be received by client 120.

In step 504, client 120 updates different portions of the topology view 402 at different times based on arrival of the events at client 120. As an example, when events specific to a certain topology view node in topology view 402 arrive, that node is redrawn without redrawing other nodes in topology view 402. For example, when a ‘node name changed’ event is received by topology view 402, the node that is associated with the name change is re-drawn without redrawing other nodes in topology view 402.

In this way, a user or viewer of topology view 402 need not wait for all nodes in topology view 402 to be rendered at the same time.

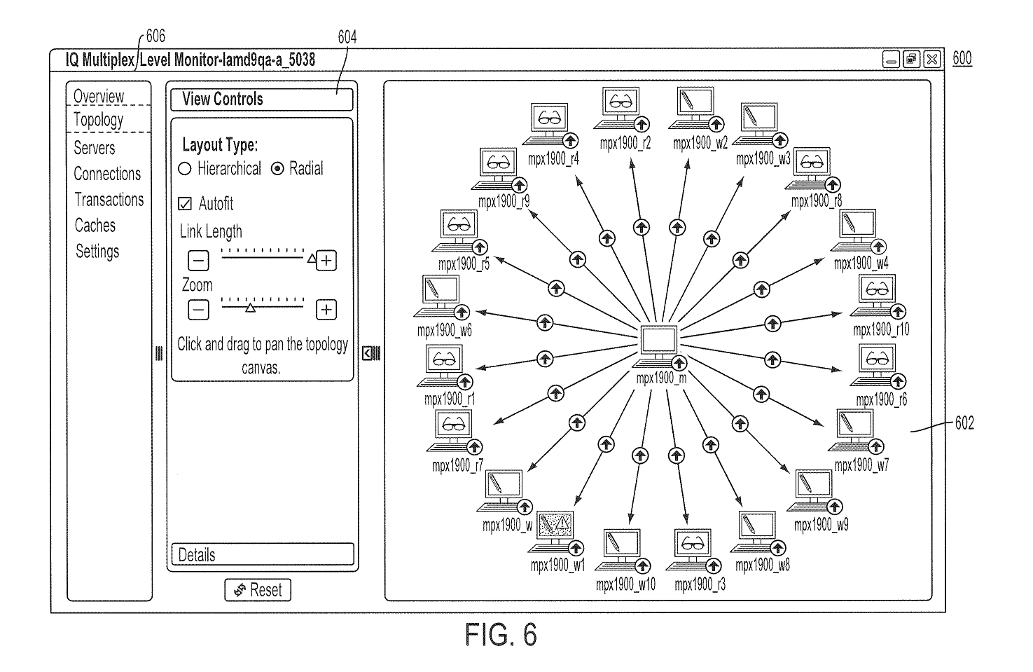

FIG. 6 illustrates an exemplary screen-shot of a topology view in client 120, according to an embodiment.

FIG. 6 includes topology view 602, view controls 604 and menu 606. In an embodiment, topology view 602 is rendered based on events published by MOs in monitor server 110. In an embodiment, view controls 604 allow a user (e.g., network administrator) to control a layout format of topology view nodes displayed in topology view 602. Furthermore, view controls can allow a user to zoom in or zoom out of topology view 602. Menu 606 may be used to control connections, transactions and other settings associated with monitor server 110.

### Example Computer Embodiment

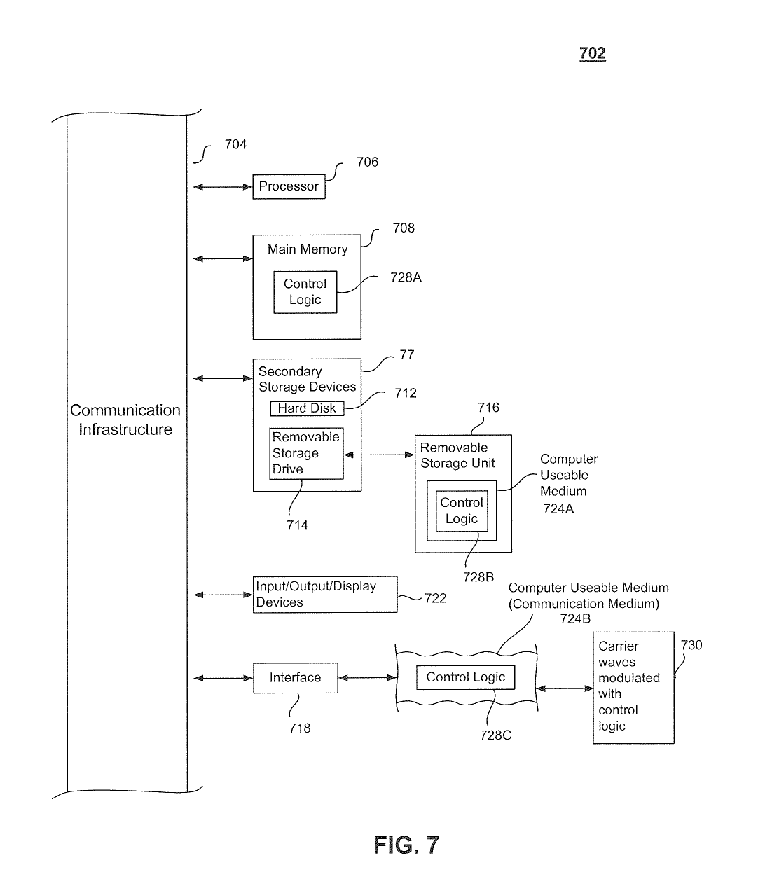

In an embodiment of the present invention, the system and components of embodiments described herein are implemented using well known computers, such as computer 702 shown in FIG. 7. For example, monitor server 110, computing nodes or resources in server cloud 140, client 120 and messaging system 130 can be implemented using computer(s) 702.

The computer 702 can be any commercially available and well known computer capable of performing the functions described herein, such as computers available from International Business Machines, Apple, Sun, HP, Dell, Compaq, Digital, Cray, etc.

The computer 702 includes one or more processors (also called central processing units, or CPUs), such as a processor 706. The processor 706 is connected to a communication bus 704.

The computer 702 also includes a main or primary memory 708, such as random access memory (RAM). The primary memory 708 has stored therein control logic 728A (computer software), and data.

The computer 702 also includes one or more secondary storage devices 710. The secondary storage devices 710 include, for example, a hard disk drive 712 and/or a removable storage device or drive 714, as well as other types of storage devices, such as memory cards and memory sticks. The removable storage drive 714 represents a floppy disk drive, a magnetic tape drive, a compact disk drive, an optical storage device, tape backup, etc.

The removable storage drive 714 interacts with a removable storage unit 716. The removable storage unit 716 includes a computer useable or readable storage medium 724 having stored therein computer software 728B (control logic) and/or data. Removable storage unit 716 represents a floppy disk, magnetic tape, compact disk, DVD, optical storage disk, or any other computer data storage device. The removable storage drive 714 reads from and/or writes to the removable storage unit 716 in a well known manner.

The computer 702 also includes input/output/display devices 722, such as monitors, keyboards, pointing devices, etc.

The computer 702 further includes a communication or network interface 718. The network interface 718 enables the computer 702 to communicate with remote devices. For example, the network interface 718 allows the computer 702 to communicate over communication networks or mediums 724B (representing a form of a computer useable or readable medium), such as LANs, WANs, the Internet, etc. The network interface 718 may interface with remote sites or networks via wired or wireless connections.

Control logic 728C may be transmitted to and from the computer 702 via the communication medium 724B. More particularly, the computer 702 may receive and transmit carrier waves (electromagnetic signals) modulated with control logic 730 via the communication medium 724B.

Any apparatus or manufacture comprising a computer useable or readable medium having control logic (software) stored therein is referred to herein as a computer program product or program storage device. This includes, but is not limited to, the computer 702, the main memory 708, secondary storage devices 710, the removable storage unit 716 and the carrier waves modulated with control logic 730. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method to monitor a plurality of computing nodes in a server cloud, comprising:
determining a topological relationship of said computing nodes;
constructing a data structure representing said topological relationship;
generating a topology view based on said constructed data structure; and
updating said topology view based on changes to said topological relationship of said computing nodes.

2. The method of claim 1, further comprising:
instantiating a plurality of node managed objects as nodes of said data structure, wherein each node managed object corresponds to a computing node of said plurality of computing nodes; and
instantiating a plurality of link managed objects as nodes of said data structure, wherein each link managed object corresponds to inter-node communications between two or more computing nodes represented by said node managed objects.

3. The method of claim 2, further comprising:
(a) determining changes to membership of said computing nodes in said server cloud;
(b) determining changes to said topological relationship of said computing nodes in said server cloud;
(c) determining changes to state and attributes of said computing nodes, and said inter-node communications in said server cloud; and
(d) publishing events, using said node managed objects and said link managed objects, based on changes determined in steps (a)-(c).

4. The method of claim 3, further comprising
providing said published events to a messaging system; and
providing said published events to one or more clients configured to display said topology view.

5. The method of claim 4, further comprising:
rendering one or more components of said topology view based on said published events.

6. A computer-based system configured to monitor a plurality of computing nodes in a server cloud, comprising:
a first module configured to determine a topological relationship of said computing nodes;
a second module configured to construct a data structure representing said topological relationship;
a third module configured to generate a topology view based on said constructed data structure; and
a fourth module configured to update said topology view based on changes to said topological relationship of said computing nodes.

7. The system of claim 6, further comprising:
a fifth module configured to instantiate a plurality of node managed objects as nodes of said data structure, wherein each node managed object corresponds to a computing node of said plurality of computing nodes; and
a sixth module configured to instantiate a plurality of link managed objects as nodes of said data structure, wherein each link managed object corresponds to inter-node communications between one or more computing nodes represented by said node managed objects.

8. The system of claim 7, wherein said node managed objects and said link managed objects are configured to independently collect data in parallel from said computing nodes.

9. The system of claim 7, wherein said node managed objects are configured to asynchronously publish events corresponding to said changes to said topological relationship of said computing nodes.

10. The system of claim 7, wherein said node managed objects are represented by a node container managed object, and wherein said link managed objects are represented by a link container managed object.

11. The system of claim 6, wherein said data structure is a node tree data structure.

12. A computer-based system configured to monitor a plurality of computing nodes in a server cloud, comprising:
a first module configured to receive events from one or more node managed objects and link managed objects, wherein said node managed objects represent a topological relationship of said computing nodes, and wherein said link managed objects correspond to inter-node communications between two or more computing nodes represented by said node managed objects; and
a second module configured to update one or more view components of a topology view based on said events.

13. The system of claim 12, further comprising a browser configured to display said topology view.

14. The system of claim 12, wherein said node managed objects further comprise one or more attributes based on a state of said computing nodes.

15. The system of claim 14, wherein said attributes comprise:
a node topological role attribute to represent a computing node's role in said topological relationship;
a node mode attribute to indicate when a computing node has been either included in or excluded from said topological relationship;
a node name attribute to represent a name associated with a computing node; and
a designated failover node attribute to indicate when a computing node is a designated failover node.

16. An article of manufacture including a computer-readable medium having instructions stored thereon that, if executed by a computing device, cause said computing device to perform operations comprising:
determining a topological relationship of said computing nodes;
constructing a data structure representing said topological relationship;
generating a topology view based on said constructed data structure; and
updating said topology view based on changes to said topological relationship of said computing nodes.

17. The article of manufacture of claim 16, said operations further comprising:
instantiating a plurality of node managed objects as nodes of said data structure, wherein each node managed object corresponds to a computing node of said plurality of computing nodes; and
instantiating a plurality of link managed objects as nodes of said data structure, wherein each link managed object corresponds to inter-node communications between two or more computing nodes represented by said node managed objects.

18. The article of manufacture of claim 17, said operations further comprising:
(a) determining changes to membership of said computing nodes in said server cloud;
(b) determining changes to said topological relationship;
(c) determining changes to state and attributes of said computing nodes and said inter-node communications; and
(d) publishing events, using said node managed objects, based on the changes determined in steps (a)-(c).

19. The article of manufacture of claim 18, said operations further comprising:
providing said published events to a messaging system; and
providing said published events to one or more clients configured to display said topology view.

20. The article of manufacture of claim 19, said operations further comprising:
rendering one or more components of said topology view based on said published events.
